(19) United States
(12) Patent Application Publication
(10) Pub. No.: US 2020/0221077 A1
(43) Pub. Date: Jul. 9, 2020

(54) INTER PREDICTION MODE-BASED IMAGE PROCESSING METHOD AND APPARATUS THEREFOR

(71) Applicant: LG ELECTRONICS INC., Seoul (KR)

(72) Inventors: Naeri PARK, Seoul (KR); Junghak NAM, Seoul (KR); Hyeongmoon JANG, Seoul (KR); Jungdong SEO, Seoul (KR); Jaeho LEE, Seoul (KR)

(21) Appl. No.: 16/644,442

(22) PCT Filed: Mar. 19, 2018
(86) PCT No.: PCT/KR2018/003182

§ 371 Date: Mar. 4, 2020

Related U.S. Application Data
(60) Provisional application No. 62/554,031, filed on Sep. 5, 2017.

(51) Int. Cl. H04N 19/105; H04N 19/513; H04N 19/176

(52) U.S. Cl. CPC H04N 19/105; H04N 19/176; H04N 19/513

(57) ABSTRACT

In the present disclosure, an inter prediction mode based image processing method and an apparatus therefor are disclosed. Specifically, a method of processing an image on the basis of an inter prediction mode may comprise a step of forming a plurality of candidate groups by checking merge candidates according to a predetermined order; a step of extracting a group index indicating a specific candidate group among the plurality of candidate groups; a step of extracting a merge index indicating the specific merge candidate in the candidate group indicated by the group index; and a step of generating a prediction block of a current block using motion information of the merge candidate indicated by the merge index.

### TECHNICAL FIELD

The present disclosure relates to a still image or moving image process method and, more particularly, to a method of encoding/decoding a still image or moving image based on an inter prediction mode and an apparatus supporting the same.

### BACKGROUND ART

Compression encoding means a series of signal processing techniques for transmitting digitized information through a communication line or techniques for storing information in a form suitable for a storage medium. The medium including a picture, an image, audio, etc. may be a target of compression encoding. Particularly, a technique for performing compression encoding on a picture is referred to as video image compression.

Next-generation video content will have characteristics, such as high spatial resolution, a high frame rate and high dimensionality of scene representation. In order to process such content, a drastic increase in the memory storage, memory access rate and processing power will result.

Accordingly, it is necessary to design a coding tool for efficiently processing next-generation video content.

### DISCLOSURE

### Technical Problem

The disclosure proposes a method of efficiently configuring a candidate list (i.e., merge candidate list) for a merge mode in performing an inter prediction (interframe prediction).

Furthermore, the disclosure proposes a method of grouping merge candidates into several candidate groups.

Furthermore, the disclosure proposes a method of configuring an optimized merge candidate list by considering various merge candidates.

Technical objects to be achieved in the disclosure are not limited to the aforementioned technical objects, and other technical objects not described above may be evidently understood by a person having ordinary skill in the art to which the disclosure pertains from the following description.

### Technical Solution

In an aspect of the disclosure, a method of processing an image based on an inter prediction mode includes checking merge candidates according to a predetermined sequence and configuring a plurality of candidate groups, extracting a group index indicating a specific candidate group among the plurality of candidate groups, extracting a merge index indicating a specific merge candidate within a candidate group indicated by the group index, and generating a prediction block of a current block using motion information of a merge candidate indicated by the merge index, wherein the plurality of candidate groups may include a first candidate group including motion information of a spatial neighbor block of the current block and a second candidate group including motion information of a temporal neighbor block of the current block.

Preferably, the plurality of candidate groups may further include a third candidate group including a combined merge candidate which is a combination of motion vectors of candidates of the first candidate group or the second candidate group.

Preferably, a less bit may be assigned to a group index indicating the first candidate group than to a group index indicating the second candidate group.

Preferably, the first candidate group may include at least one of the motion vector of a block including a pixel horizontally or vertically neighboring a top left pixel of the current block, the median of motion vectors of blocks neighboring a left side of the current block or the median of motion vectors of blocks neighboring an upper side of the current block.

Preferably, the second candidate group may include a first advanced temporal merge candidate using, as a subblock unit, the motion vector of a reference block specified by the motion vector of a specific merge candidate of the first candidate group.

Preferably, the second candidate group may include a second advanced temporal merge candidate using, as a subblock unit, an average value or median of the motion vectors of a spatial neighbor block and temporal neighbor block of the current block.

Preferably, the second candidate group may include a third advanced temporal merge candidate using the motion vector at a top left location or middle location of a reference block, which is specified by the motion vector of a specific merge candidate of the first candidate group.

Preferably, the second candidate group may include a motion vector of a first block including a pixel corresponding to a pixel located to left above from a middle location of the current block or a second block including a pixel corresponding to a top left pixel of the current block, the first and second blocks belonging to a temporal candidate picture

Preferably, extracting the group index may include determining whether to extract the group index based on a value of the merge index. The group index indicating a specific candidate group may be extracted among the plurality of candidate groups based on a result of the determination of the extraction.

Preferably, whether to extract the group index may be determined based on whether the value of the merge index exceeds a preset value.

Preferably, extracting the group index may include confirming whether a reference picture of the current block corresponds to a slice coded through an intra prediction. The group index indicating a specific candidate group may be extracted among the plurality of candidate groups if, as a result of the confirmation, the reference picture of the current block does not correspond to a slice coded through an intra prediction.

In another aspect of the disclosure, an apparatus for processing video based on an inter prediction mode includes a candidate group construction unit configured to check merge candidates according to a predetermined sequence and configuring a plurality of candidate groups, a group index extraction unit configured to extract a group index indicating a specific candidate group among the plurality of candidate groups, a merge index extraction unit configured to extract a merge index indicating a specific merge candidate within a candidate group indicated by the group index, and a prediction block generation unit configured to generate a prediction block of a current block using motion information of a merge candidate indicated by the merge index, wherein the plurality of candidate groups may include a first candidate group including motion information of a spatial neighbor block of the current block and a second candidate group including motion information of a temporal neighbor block of the current block.

### Advantageous Effects

According to an embodiment of the disclosure, the accuracy of a prediction can be enhanced and coding efficiency can be improved by generating a merge candidate list by considering more candidates compared to the existing method.

Effects which may be obtained in the disclosure are not limited to the aforementioned effects, and other technical effects not described above may be evidently understood by a person having ordinary skill in the art to which the disclosure pertains from the following description.

### DESCRIPTION OF DRAWINGS

The accompanying drawings, which are included herein as a part of the description for help understanding the disclosure, provide embodiments of the disclosure, and describe the technical features of the disclosure with the description below.

FIG. 1 is illustrates a schematic block diagram of an encoder in which the encoding of a still image or video signal is performed, as an embodiment to which the disclosure is applied.

FIG. 2 illustrates a schematic block diagram of a decoder in which the decoding of a still image or video signal is performed, as an embodiment to which the disclosure is applied.

FIG. 3 is a diagram for describing a split structure of a coding unit that may be applied to the disclosure.

FIG. 4 is a diagram for describing a prediction unit which may be applied to the disclosure.

FIG. 5 is an embodiment to which the disclosure may be applied and is a diagram illustrating directions of inter-prediction.

FIG. 6 is an embodiment to which the disclosure may be applied and illustrates integers for ¼ sample interpolation and fraction sample locations.

FIG. 7 is an embodiment to which the disclosure may be applied and illustrates the location of a spatial candidate.

FIG. 8 is an embodiment to which the disclosure is applied and is a diagram illustrating an inter-prediction method.

FIG. 9 is an embodiment to which the disclosure may be applied and is a diagram illustrating a motion compensation process.

FIG. 10 is an embodiment to which the disclosure is applied, and is a diagram for describing a method of generating a merge candidate list using spatially neighboring blocks or temporally neighboring blocks.

FIG. 11 is an embodiment to which the disclosure is applied, and is a diagram illustrating a method of grouping merge candidates.

FIG. 12 is an embodiment to which the disclosure is applied, and is a diagram for describing a method of configuring a merge candidate group using the motion vectors of spatially neighboring blocks.

FIG. 13 is an embodiment to which the disclosure is applied, and is a diagram for describing a method of configuring a merge candidate group using the motion vectors of temporally neighboring blocks.

FIG. 14 is an embodiment to which the disclosure is applied, and is a diagram for describing a method of configuring a merge candidate group using combined merge candidates.

FIG. 15 is an embodiment to which the disclosure is applied, and is a diagram illustrating a method of grouping merge candidates.

FIG. 16 is a diagram illustrating a method of configuring a merge candidate group using the motion vectors of spatially neighboring blocks according to an embodiment of the disclosure.

FIG. 17 is a diagram illustrating a method of configuring a merge candidate group using the motion vectors of temporally neighboring blocks according to an embodiment of the disclosure.

FIG. 18 is an embodiment to which the disclosure is applied, and is a diagram for describing a method of checking merge candidates in order to configure a merge candidate group.

FIG. 19 is a diagram for describing an inter prediction method according to an embodiment of the disclosure.

FIG. 20 is a diagram more specifically illustrating an inter prediction unit according to an embodiment of the disclosure.

### MODE FOR INVENTION

Hereinafter, a preferred embodiment of the disclosure will be described by reference to the accompanying drawings. The description that will be described below with the accompanying drawings is to describe exemplary embodiments of the disclosure, and is not intended to describe the only embodiment in which the disclosure may be implemented. The description below includes particular details in order to provide perfect understanding of the disclosure. However, it is understood that the disclosure may be embodied without the particular details to those skilled in the art.

In some cases, in order to prevent the technical concept of the disclosure from being unclear, structures or devices which are publicly known may be omitted, or may be depicted as a block diagram centering on the core functions of the structures or the devices.

Further, although general terms widely used currently are selected as the terms in the disclosure as much as possible, a term that is arbitrarily selected by the applicant is used in a specific case. Since the meaning of the term will be clearly described in the corresponding part of the description in such a case, it is understood that the disclosure will not be simply interpreted by the terms only used in the description of the disclosure, but the meaning of the terms should be figured out.

Specific terminologies used in the description below may be provided to help the understanding of the disclosure. Furthermore, the specific terminology may be modified into other forms within the scope of the technical concept of the disclosure. For example, a signal, data, a sample, a picture, a frame, a block, etc may be properly replaced and interpreted in each coding process.

Hereinafter, in this disclosure, a “processing unit” means a unit in which an encoding/decoding processing process, such as a prediction, a transform and/or quantization, is performed. Hereinafter, for convenience of description, a processing unit may also be called “processing block” or “block.”

A processing unit may be construed as having a meaning including a unit for a luma component and a unit for a chroma component. For example, a processing unit may correspond to a coding tree unit (CTU), a coding unit (CU), a prediction unit (PU) or a transform unit (TU).

Furthermore, a processing unit may be construed as being a unit for a luma component or a unit for a chroma component. For example, the processing unit may correspond to a coding tree block (CTB), coding block (CB), prediction block (PB) or transform block (TB) for a luma component. Alternatively, a processing unit may correspond to a coding tree block (CTB), coding block (CB), prediction block (PU) or transform block (TB) for a chroma component. Also, the disclosure is not limited to this, and the processing unit may be interpreted to include a unit for the luma component and a unit for the chroma component.

Furthermore, a processing unit is not essentially limited to a square block and may be constructed in a polygon form having three or more vertices.

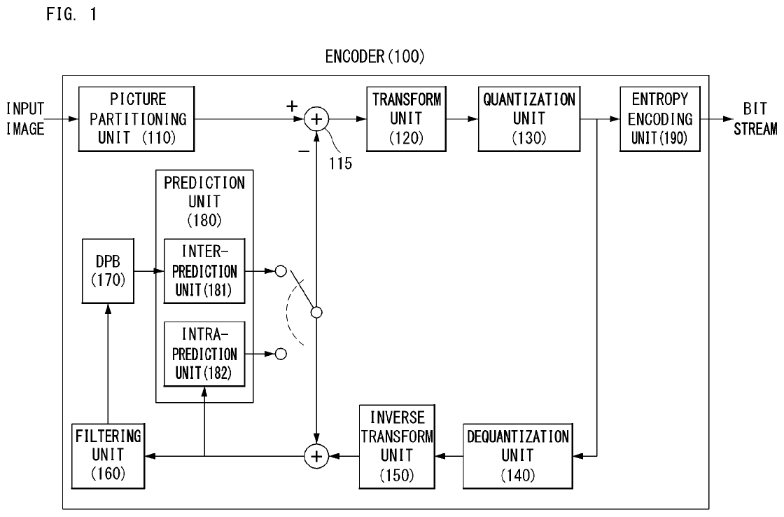

FIG. 1 is illustrates a schematic block diagram of an encoder in which the encoding of a still image or video signal is performed, as an embodiment to which the disclosure is applied.

Referring to FIG. 1, the encoder 100 may include a video split unit 110, a subtractor 115, a transform unit 120, a quantization unit 130, a dequantization unit 140, an inverse transform unit 150, a filtering unit 160, a decoded picture buffer (DPB) 170, a prediction unit 180 and an entropy encoding unit 190. Furthermore, the prediction unit 180 may include an inter-prediction unit 181 and an intra-prediction unit 182.

The video split unit 110 splits an input video signal (or picture or frame), input to the encoder 100, into one or more processing units.

The subtractor 115 generates a residual signal (or residual block) by subtracting a prediction signal (or prediction block), output by the prediction unit 180 (i.e., by the inter-prediction unit 181 or the intra-prediction unit 182), from the input video signal. The generated residual signal (or residual block) is transmitted to the transform unit 120.

The transform unit 120 generates transform coefficients by applying a transform scheme (e.g., discrete cosine transform (DCT), discrete sine transform (DST), graph-based transform (GBT) or Karhunen-Loeve transform (KLT)) to the residual signal (or residual block). In this case, the transform unit 120 may generate transform coefficients by performing transform using a prediction mode applied to the residual block and a transform scheme determined based on the size of the residual block.

The quantization unit 130 quantizes the transform coefficient and transmits it to the entropy encoding unit 190, and the entropy encoding unit 190 performs an entropy coding operation of the quantized signal and outputs it as a bit stream.

Meanwhile, the quantized signal outputted by the quantization unit 130 may be used to generate a prediction signal. For example, a residual signal may be reconstructed by applying dequatization and inverse transformation to the quantized signal through the dequantization unit 140 and the inverse transform unit 150. A reconstructed signal may be generated by adding the reconstructed residual signal to the prediction signal output by the inter-prediction unit 181 or the intra-prediction unit 182.

Meanwhile, during such a compression process, neighbor blocks are quantized by different quantization parameters. Accordingly, an artifact in which a block boundary is shown may occur. Such a phenomenon is referred to a blocking artifact, which is one of important factors for evaluating image quality. In order to decrease such an artifact, a filtering process may be performed. Through such a filtering process, the blocking artifact is removed and the error of a current picture is decreased at the same time, thereby improving image quality.

The filtering unit 160 applies filtering to the reconstructed signal, and outputs it through a playback device or transmits it to the decoded picture buffer 170. The filtered signal transmitted to the decoded picture buffer 170 may be used as a reference picture in the inter-prediction unit 181. As described above, an encoding rate as well as image quality can be improved using the filtered picture as a reference picture in an inter-picture prediction mode.

The decoded picture buffer 170 may store the filtered picture in order to use it as a reference picture in the inter-prediction unit 181.

The inter-prediction unit 181 performs temporal prediction and/or spatial prediction with reference to the reconstructed picture in order to remove temporal redundancy and/or spatial redundancy.

Particularly, the inter prediction unit 181 according to the disclosure may use inverse direction motion information in an inter prediction (or interframe prediction) process. This is described later more specifically.

In this case, a blocking artifact or ringing artifact may occur because a reference picture used to perform prediction is a transformed signal that experiences quantization or dequantization in a block unit when it is previously encoded/decoded.

Accordingly, in order to solve performance degradation attributable to the discontinuity of such a signal or quantization, signals between pixels may be interpolated in a sub-pixel unit by applying a low pass filter to the inter-prediction unit 181. In this case, the sub-pixel means a virtual pixel generated by applying an interpolation filter, and an integer pixel means an actual pixel that is present in a reconstructed picture. A linear interpolation, a bi-linear interpolation, a wiener filter, and the like may be applied as an interpolation method.

The interpolation filter may be applied to the reconstructed picture, and may improve the accuracy of prediction. For example, the inter-prediction unit 181 may perform prediction by generating an interpolation pixel by applying the interpolation filter to the integer pixel and by using the interpolated block including interpolated pixels as a prediction block.

The intra-prediction unit 182 predicts a current block with reference to samples neighboring the block that is now to be encoded. The intra-prediction unit 182 may perform the following procedure in order to perform intra-prediction. First, the intra-prediction unit 182 may prepare a reference sample necessary to generate a prediction signal. Furthermore, the intra-prediction unit 182 may generate a prediction signal using the prepared reference sample. Next, the intra-prediction unit 182 may encode a prediction mode. In this case, the reference sample may be prepared through reference sample padding and/or reference sample filtering. A quantization error may be present because the reference sample experiences the prediction and the reconstruction process. Accordingly, in order to reduce such an error, a reference sample filtering process may be performed on each prediction mode used for the intra-prediction.

The prediction signal (or prediction block) generated through the inter-prediction unit 181 or the intra-prediction unit 182 may be used to generate a reconstructed signal (or reconstructed block) or may be used to generate a residual signal (or residual block).

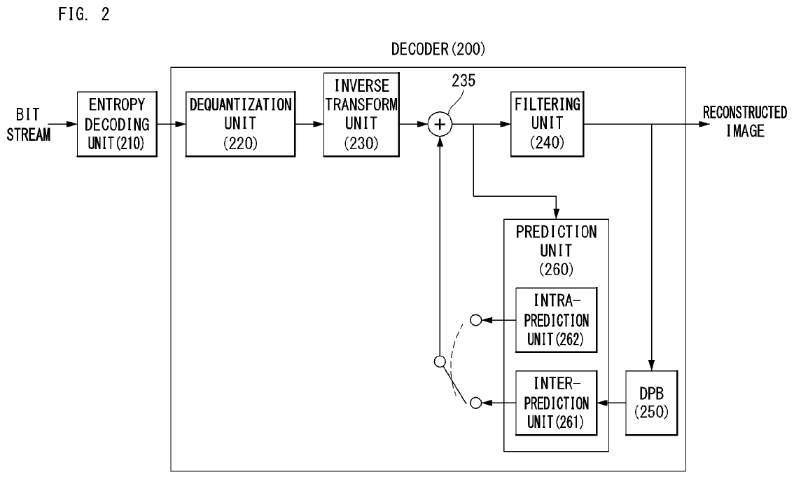

FIG. 2 illustrates a schematic block diagram of a decoder in which decoding of a still image or video signal is performed, as an embodiment to which the disclosure is applied.

Referring to FIG. 2, the decoder 200 may include an entropy decoding unit 210, a dequantization unit 220, an inverse transform unit 230, an adder 235, a filtering unit 240, a decoded picture buffer (DPB) 250 and a prediction unit 260. Furthermore, the prediction unit 260 may include an inter-prediction unit 261 and an intra-prediction unit 262.

Furthermore, a reconstructed video signal output through the decoder 200 may be played back through a playback device.

The decoder 200 receives a signal (i.e., bit stream) output by the encoder 100 shown in FIG. 1. The entropy decoding unit 210 performs an entropy decoding operation on the received signal.

The dequantization unit 220 obtains transform coefficients from the entropy-decoded signal using quantization step size information.

The inverse transform unit 230 obtains a residual signal (or residual block) by inverse transforming the transform coefficients by applying an inverse transform scheme.

The adder 235 adds the obtained residual signal (or residual block) to the prediction signal (or prediction block) output by the prediction unit 260 (i.e., the inter-prediction unit 261 or the intra-prediction unit 262), thereby generating a reconstructed signal (or reconstructed block).

The filtering unit 240 applies filtering to the reconstructed signal (or reconstructed block) and outputs the filtered signal to a playback device or transmits the filtered signal to the decoded picture buffer 250. The filtered signal transmitted to the decoded picture buffer 250 may be used as a reference picture in the inter-prediction unit 261.

In this disclosure, the embodiments described in the filtering unit 160, inter-prediction unit 181 and intra-prediction unit 182 of the encoder 100 may be identically applied to the filtering unit 240, inter-prediction unit 261 and intra-prediction unit 262 of the decoder, respectively.

Particularly, the inter prediction unit 261 according to the disclosure may use inverse direction motion information in an inter prediction (or interframe prediction) process. This is described later more specifically.

Processing Unit Split Structure

In general, a block-based image compression method is used in the compression technique (e.g., HEVC) of a still image or a video. The block-based image compression method is a method of processing an image by splitting it into specific block units, and may decrease memory use and a computational load.

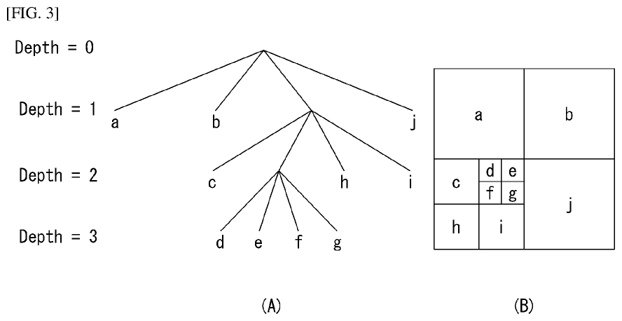

FIG. 3 is a diagram for describing a split structure of a coding unit which may be applied to the disclosure.

An encoder splits a single image (or picture) into coding tree units (CTUs) of a quadrangle form, and sequentially encodes the CTUs one by one according to raster scan order.

In HEVC, a size of CTU may be determined as one of 64×64, 32×32, and 16×16. The encoder may select and use the size of a CTU based on resolution of an input video signal or the characteristics of input video signal. The CTU includes a coding tree block (CTB) for a luma component and the CTB for two chroma components that correspond to it.

One CTU may be split in a quad-tree structure. That is, one CTU may be split into four units each having a square form and having a half horizontal size and a half vertical size, thereby being capable of generating coding units (CUs). Such splitting of the quad-tree structure may be recursively performed. That is, the CUs are hierarchically split from one CTU in the quad-tree structure.

A CU means a basic unit for the processing process of an input video signal, for example, coding in which intra/inter prediction is performed. A CU includes a coding block (CB) for a luma component and a CB for two chroma components corresponding to the luma component. In HEVC, a CU size may be determined as one of 64×64, 32×32, 16×16, and 8×8.

Referring to FIG. 3, the root node of a quad-tree is related to a CTU. The quad-tree is split until a leaf node is reached. The leaf node corresponds to a CU.

This is described in more detail. The CTU corresponds to the root node and has the smallest depth (i.e., depth=0) value. A CTU may not be split depending on the characteristics of an input video signal. In this case, the CTU corresponds to a CU.

A CTU may be split in a quad-tree form. As a result, lower nodes, that is, a depth 1 (depth=1), are generated. Furthermore, a node (i.e., leaf node) that belongs to the lower nodes having the depth of 1 and that is no longer split corresponds to a CU. For example, in FIG. 3(b), a CU(a), a CU(b) and a CU(j) corresponding to nodes a, b and j have been once split from the CTU, and have a depth of 1.

At least one of the nodes having the depth of 1 may be split in a quad-tree form. As a result, lower nodes having a depth 1 (i.e., depth=2) are generated. Furthermore, a node (i.e., leaf node) that belongs to the lower nodes having the depth of 2 and that is no longer split corresponds to a CU. For example, in FIG. 3(b), a CU(c), a CU(h) and a CU(i) corresponding to nodes c, h and i have been twice split from the CTU, and have a depth of 2.

Furthermore, at least one of the nodes having the depth of 2 may be split in a quad-tree form again. As a result, lower nodes having a depth 3 (i.e., depth=3) are generated. Furthermore, a node (i.e., leaf node) that belongs to the lower nodes having the depth of 3 and that is no longer split corresponds to a CU. For example, in FIG. 3(b), a CU(d), a CU(e), a CU(f) and a CU(g) corresponding to nodes d, e, f and g have been three times split from the CTU, and have a depth of 3.

In the encoder, a maximum size or minimum size of a CU may be determined based on the characteristics of a video image (e.g., resolution) or by considering the encoding rate. Furthermore, information about the maximum or minimum size or information capable of deriving the information may be included in a bit stream. A CU having a maximum size is referred to as the largest coding unit (LCU), and a CU having a minimum size is referred to as the smallest coding unit (SCU).

In addition, a CU having a tree structure may be hierarchically split with predetermined maximum depth information (or maximum level information). Furthermore, each split CU may have depth information. Since the depth information represents a split count and/or degree of a CU, it may include information about the size of a CU.

Since the LCU is split in a Quad-tree shape, the size of SCU may be obtained by using a size of LCU and the maximum depth information. Or, inversely, the size of LCU may be obtained by using a size of SCU and the maximum depth information of the tree.

For a single CU, the information (e.g., a split CU flag (split cu flag)) that represents whether the corresponding CU is split may be forwarded to the decoder. This split information is included in all CUs except the SCU. For example, when the value of the flag that represents whether to split is ‘1’, the corresponding CU is further split into four CUs, and when the value of the flag that represents whether to split is ‘0’, the corresponding CU is not split any more, and the processing process for the corresponding CU may be performed.

As described above, a CU is a basic unit of the coding in which the intra-prediction or the inter-prediction is performed. The HEVC splits the CU in a prediction unit (PU) for coding an input video signal more effectively.

A PU is a basic unit for generating a prediction block, and even in a single CU, the prediction block may be generated in different way by a unit of PU. However, the intra-prediction and the inter-prediction are not used together for the PUs that belong to a single CU, and the PUs that belong to a single CU are coded by the same prediction method (i.e., the intra-prediction or the inter-prediction).

A PU is not split in the Quad-tree structure, but is split once in a single CU in a predetermined shape. This will be described by reference to the drawing below.

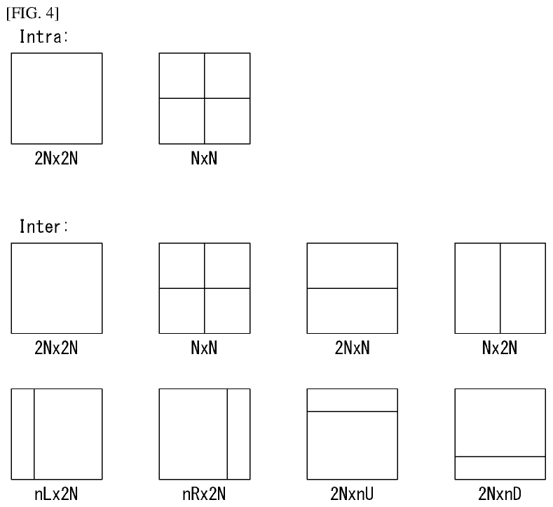

FIG. 4 is a diagram for describing a prediction unit that may be applied to the disclosure.

A PU is differently split depending on whether the intra-prediction mode is used or the inter-prediction mode is used as the coding mode of the CU to which the PU belongs.

FIG. 4(a) illustrates a PU if the intra-prediction mode is used, and FIG. 4(b) illustrates a PU if the inter-prediction mode is used.

Referring to FIG. 4(a), assuming that the size of a single CU is 2N×2N (N=4, 8, 16 and 32), the single CU may be split into two types (i.e., 2N×2N or N×N).

In this case, if a single CU is split into the PU of 2N×2N shape, it means that only one PU is present in a single CU.

Meanwhile, if a single CU is split into the PU of N×N shape, a single CU is split into four PUs, and different prediction blocks are generated for each PU unit. However, such PU splitting may be performed only if the size of CB for the luma component of CU is the minimum size (i.e., the case that a CU is an SCU).

Referring to FIG. 4(b), assuming that the size of a single CU is 2N×2N (N=4, 8, 16 and 32), a single CU may be split into eight PU types (i.e., 2N×2N, N×N, 2N×N, N×2N, nL×2N, nR×2N, 2N×nU and 2N×nD)

As in the intra-prediction, the PU split of N×N shape may be performed only if the size of CB for the luma component of CU is the minimum size (i.e., the case that a CU is an SCU).

The inter-prediction supports the PU split in the shape of 2N×N that is split in a horizontal direction and in the shape of N×2N that is split in a vertical direction.

In addition, the inter-prediction supports the PU split in the shape of nL×2N, nR×2N, 2N×nU and 2N×nD, which is an asymmetric motion split (AMP). In this case, ‘n’ means ¼ value of 2N. However, the AMP may not be used if the CU to which the PU is belonged is the CU of minimum size.

In order to encode the input video signal in a single CTU efficiently, the optimal split structure of the coding unit (CU), the prediction unit (PU) and the transform unit (TU) may be determined based on a minimum rate-distortion value through the processing process as follows. For example, as for the optimal CU split process in a 64×64 CTU, the rate-distortion cost may be calculated through the split process from a CU of 64×64 size to a CU of 8×8 size. The detailed process is as follows.

1) The optimal split structure of a PU and TU that generates the minimum rate distortion value is determined by performing inter/intra-prediction, transformation/quantization, dequantization/inverse transformation and entropy encoding on the CU of 64×64 size.

2) The optimal split structure of a PU and TU is determined to split the 64×64 CU into four CUs of 32×32 size and to generate the minimum rate distortion value for each 32×32 CU.

3) The optimal split structure of a PU and TU is determined to further split the 32×32 CU into four CUs of 16×16 size and to generate the minimum rate distortion value for each 16×16 CU.

4) The optimal split structure of a PU and TU is determined to further split the 16×16 CU into four CUs of 8×8 size and to generate the minimum rate distortion value for each 8×8 CU.

5) The optimal split structure of a CU in the 16×16 block is determined by comparing the rate-distortion value of the 16×16 CU obtained in the process 3) with the addition of the rate-distortion value of the four 8×8 CUs obtained in the process 4). This process is also performed for remaining three 16×16 CUs in the same manner.

6) The optimal split structure of CU in the 32×32 block is determined by comparing the rate-distortion value of the 32×32 CU obtained in the process 2) with the addition of the rate-distortion value of the four 16×16 CUs that is obtained in the process 5). This process is also performed for remaining three 32×32 CUs in the same manner.

7) Finally, the optimal split structure of CU in the 64×64 block is determined by comparing the rate-distortion value of the 64×64 CU obtained in the process 1) with the addition of the rate-distortion value of the four 32×32 CUs obtained in the process 6).

In the intra-prediction mode, a prediction mode is selected as a PU unit, and prediction and reconstruction are performed on the selected prediction mode in an actual TU unit.

A TU means a basic unit in which actual prediction and reconstruction are performed. A TU includes a transform block (TB) for a luma component and a TB for two chroma components corresponding to the luma component.

In the example of FIG. 3, as in an example in which one CTU is split in the quad-tree structure to generate a CU, a TU is hierarchically split from one CU to be coded in the quad-tree structure.

TUs split from a CU may be split into smaller and lower TUs because a TU is split in the quad-tree structure. In HEVC, the size of a TU may be determined to be as one of 32×32, 16×16, 8×8 and 4×4.

Referring back to FIG. 3, the root node of a quad-tree is assumed to be related to a CU. The quad-tree is split until a leaf node is reached, and the leaf node corresponds to a TU.

This is described in more detail. A CU corresponds to a root node and has the smallest depth (i.e., depth=0) value. A CU may not be split depending on the characteristics of an input image. In this case, the CU corresponds to a TU.

A CU may be split in a quad-tree form. As a result, lower nodes having a depth 1 (depth=1) are generated. Furthermore, a node (i.e., leaf node) that belongs to the lower nodes having the depth of 1 and that is no longer split corresponds to a TU. For example, in FIG. 3(b), a TU(a), a TU(b) and a TU(j) corresponding to the nodes a, b and j are once split from a CU and have a depth of 1.

At least one of the nodes having the depth of 1 may be split in a quad-tree form again. As a result, lower nodes having a depth 2 (i.e., depth=2) are generated. Furthermore, a node (i.e., leaf node) that belongs to the lower nodes having the depth of 2 and that is no longer split corresponds to a TU. For example, in FIG. 3(b), a TU(c), a TU(h) and a TU(i) corresponding to the node c, h and I have been split twice from the CU and have the depth of 2.

Furthermore, at least one of the nodes having the depth of 2 may be split in a quad-tree form again. As a result, lower nodes having a depth 3 (i.e., depth=3) are generated. Furthermore, a node (i.e., leaf node) that belongs to the lower nodes having the depth of 3 and that is no longer split corresponds to a CU. For example, in FIG. 3(b), a TU(d), a TU(e), a TU(f) and a TU(g) corresponding to the nodes d, e, f and g have been three times split from the CU and have the depth of 3.

A TU having a tree structure may be hierarchically split with predetermined maximum depth information (or maximum level information). Furthermore, each spit TU may have depth information. The depth information may include information about the size of the TU because it indicates the split number and/or degree of the TU.

Information (e.g., a split TU flag “split_transform_flag”) indicating whether a corresponding TU has been split with respect to one TU may be transferred to the decoder. The split information is included in all of TUs other than a TU of a minimum size. For example, if the value of the flag indicating whether a TU has been split is “1”, the corresponding TU is split into four TUs. If the value of the flag indicating whether a TU has been split is “0”, the corresponding TU is no longer split.

Prediction

In order to reconstruct a current processing unit on which decoding is performed, the decoded part of a current picture or other pictures including the current processing unit may be used.

A picture (slice) using only a current picture for reconstruction, that is, on which only intra-prediction is performed, may be called an intra-picture or I picture (slice), a picture (slice) using a maximum of one motion vector and reference index in order to predict each unit may be called a predictive picture or P picture (slice), and a picture (slice) using a maximum of two motion vector and reference indices may be called a bi-predictive picture or B a picture (slice).

Intra-prediction means a prediction method of deriving a current processing block from the data element (e.g., a sample value) of the same decoded picture (or slice). That is, intra-prediction means a method of predicting the pixel value of a current processing block with reference to reconstructed regions within a current picture.

Hereinafter, inter-prediction is described in more detail.

Inter-Prediction (or Inter-Frame Prediction)

Inter-prediction means a prediction method of deriving a current processing block based on the data element (e.g., sample value or motion vector) of a picture other than a current picture. That is, inter-prediction means a method of predicting the pixel value of a current processing block with reference to reconstructed regions within another reconstructed picture other than a current picture.

Inter-prediction (or inter-picture prediction) is a technology for removing redundancy present between pictures and is chiefly performed through motion estimation and motion compensation.

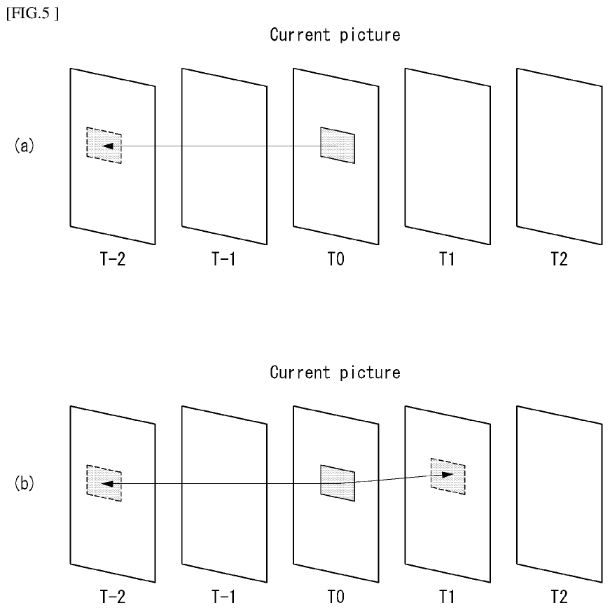

FIG. 5 is an embodiment to which the disclosure may be applied and is a diagram illustrating the direction of inter-prediction.

Referring to FIG. 5, inter-prediction may be divided into uni-direction prediction in which only one past picture or future picture is used as a reference picture on a time axis with respect to a single block and bi-directional prediction in which both the past and future pictures are referred at the same time.

Furthermore, the uni-direction prediction may be divided into forward direction prediction in which a single reference picture temporally displayed (or output) prior to a current picture is used and backward direction prediction in which a single reference picture temporally displayed (or output) after a current picture is used.

In the inter-prediction process (i.e., uni-direction or bi-directional prediction), a motion parameter (or information) used to specify which reference region (or reference block) is used in predicting a current block includes an inter-prediction mode (in this case, the inter-prediction mode may indicate a reference direction (i.e., uni-direction or bidirectional) and a reference list (i.e., L0, L1 or bidirectional)), a reference index (or reference picture index or reference list index), and motion vector information. The motion vector information may include a motion vector, motion vector prediction (MVP) or a motion vector difference (MVD). The motion vector difference means a difference between a motion vector and a motion vector predictor.

In the uni-direction prediction, a motion parameter for one-side direction is used. That is, one motion parameter may be necessary to specify a reference region (or reference block).

In the bi-directional prediction, a motion parameter for both directions is used. In the bi-directional prediction method, a maximum of two reference regions may be used. The two reference regions may be present in the same reference picture or may be present in different pictures. That is, in the bi-directional prediction method, a maximum of two motion parameters may be used. Two motion vectors may have the same reference picture index or may have different reference picture indices. In this case, the reference pictures may be displayed temporally prior to a current picture or may be displayed (or output) temporally after a current picture.

The encoder performs motion estimation in which a reference region most similar to a current processing block is searched for in reference pictures in an inter-prediction process. Furthermore, the encoder may provide the decoder with a motion parameter for a reference region.

The encoder/decoder may obtain the reference region of a current processing block using a motion parameter. The reference region is present in a reference picture having a reference index. Furthermore, the pixel value or interpolated value of a reference region specified by a motion vector may be used as the predictor of a current processing block. That is, motion compensation in which an image of a current processing block is predicted from a previously decoded picture is performed using motion information.

In order to reduce the transfer rate related to motion vector information, a method of obtaining a motion vector predictor (mvd) using motion information of previously decoded blocks and transmitting only the corresponding difference (mvd) may be used. That is, the decoder calculates the motion vector predictor of a current processing block using motion information of other decoded blocks and obtains a motion vector value for the current processing block using a difference from the encoder. In obtaining the motion vector predictor, the decoder may obtain various motion vector candidate values using motion information of other already decoded blocks, and may obtain one of the various motion vector candidate values as a motion vector predictor.

Reference Picture Set and Reference Picture List

In order to manage multiple reference pictures, a set of previously decoded pictures are stored in the decoded picture buffer (DPB) for the decoding of the remaining pictures.

A reconstructed picture that belongs to reconstructed pictures stored in the DPB and that is used for inter-prediction is called a reference picture. In other words, a reference picture means a picture including a sample that may be used for inter-prediction in the decoding process of a next picture in a decoding sequence.

A reference picture set (RPS) means a set of reference pictures associated with a picture, and includes all of previously associated pictures in the decoding sequence. A reference picture set may be used for the inter-prediction of an associated picture or a picture following a picture in the decoding sequence. That is, reference pictures retained in the decoded picture buffer (DPB) may be called a reference picture set. The encoder may provide the decoder with a sequence parameter set (SPS) (i.e., a syntax structure having a syntax element) or reference picture set information in each slice header.

A reference picture list means a list of reference pictures used for the inter-prediction of a P picture (or slice) or a B picture (or slice). In this case, the reference picture list may be divided into two reference pictures lists, which may be called a reference picture list 0 (or L0) and a reference picture list 1 (or L1). Furthermore, a reference picture belonging to the reference picture list 0 may be called a reference picture 0 (or L0 reference picture), and a reference picture belonging to the reference picture list 1 may be called a reference picture 1 (or L1 reference picture).

In the decoding process of the P picture (or slice), one reference picture list (i.e., the reference picture list 0). In the decoding process of the B picture (or slice), two reference pictures lists (i.e., the reference picture list 0 and the reference picture list 1) may be used. Information for distinguishing between such reference picture lists for each reference picture may be provided to the decoder through reference picture set information. The decoder adds a reference picture to the reference picture list 0 or the reference picture list 1 based on reference picture set information.

In order to identify any one specific reference picture within a reference picture list, a reference picture index (or reference index) is used.

Fractional Sample Interpolation

A sample of a prediction block for an inter-predicted current processing block is obtained from the sample value of a corresponding reference region within a reference picture identified by a reference picture index. In this case, a corresponding reference region within a reference picture indicates the region of a location indicated by the horizontal component and vertical component of a motion vector. Fractional sample interpolation is used to generate a prediction sample for non-integer sample coordinates except a case where a motion vector has an integer value. For example, a motion vector of ¼ scale of the distance between samples may be supported.

In the case of HEVC, fractional sample interpolation of a luma component applies an 8 tab filter in the traverse direction and longitudinal direction. Furthermore, the fractional sample interpolation of a chroma component applies a 4 tab filter in the traverse direction and the longitudinal direction.

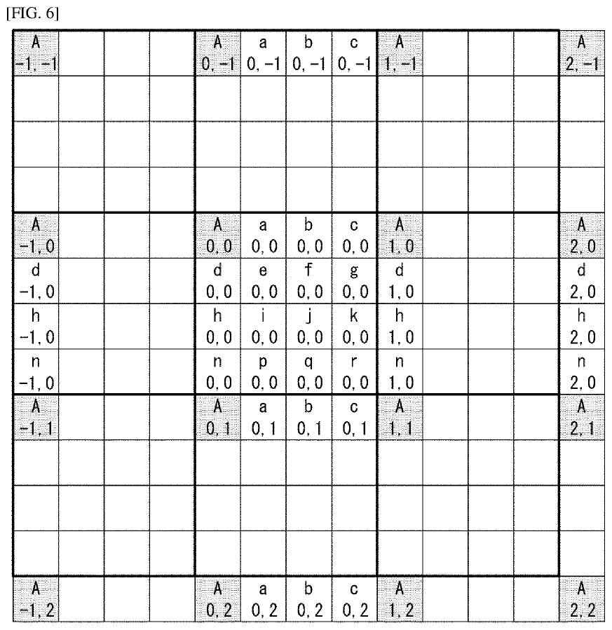

FIG. 6 is an embodiment to which the disclosure may be applied and illustrates integers for ¼ sample interpolation and a fraction sample locations.

Referring to FIG. 6, a shadow block in which an upper-case letter (A_i,j) is written indicates an integer sample location, and a block not having a shadow in which a lower-case letter (x_i,j) is written indicates a fraction sample location.

A fraction sample is generated by applying an interpolation filter to an integer sample value in the horizontal direction and the vertical direction. For example, in the case of the horizontal direction, the 8 tab filter may be applied to four integer sample values on the left side and four integer sample values on the right side based on a fraction sample to be generated.

Inter-Prediction Mode

In HEVC, in order to reduce the amount of motion information, a merge mode and advanced motion vector prediction (AMVP) may be used.

1) Merge Mode

The merge mode means a method of deriving a motion parameter (or information) from a spatially or temporally neighbor block.

In the merge mode, a set of available candidates includes spatially neighboring candidates, temporal candidates and generated candidates.

FIG. 7 is an embodiment to which the disclosure may be applied and illustrates the location of a spatial candidate.

Referring to FIG. 7(a), whether each spatial candidate block is available depending on the sequence of {A1, B1, B0, A0, B2} is determined. In this case, if a candidate block is not encoded in the intra-prediction mode and motion information is present or if a candidate block is located out of a current picture (or slice), the corresponding candidate block cannot be used.

After the validity of a spatial candidate is determined, a spatial merge candidate may be configured by excluding an unnecessary candidate block from the candidate block of a current processing block. For example, if the candidate block of a current prediction block is a first prediction block within the same coding block, candidate blocks having the same motion information other than a corresponding candidate block may be excluded.

When the spatial merge candidate configuration is completed, a temporal merge candidate configuration process is performed in order of {T0, T1}.

In a temporal candidate configuration, if the right bottom block T0 of a collocated block of a reference picture is available, the corresponding block is configured as a temporal merge candidate. The collocated block means a block present in a location corresponding to a current processing block in a selected reference picture. In contrast, if not, a block T1 located at the center of the collocated block is configured as a temporal merge candidate.

A maximum number of merge candidates may be specified in a slice header. If the number of merge candidates is greater than the maximum number, a spatial candidate and temporal candidate having a smaller number than the maximum number are maintained. If not, the number of additional merge candidates (i.e., combined bi-predictive merging candidates) is generated by combining candidates added so far until the number of candidates becomes the maximum number.

The encoder configures a merge candidate list using the above method, and signals candidate block information, selected in a merge candidate list by performing motion estimation, to the decoder as a merge index (e.g., merge_idx[x0][y0]′). FIG. 7(b) illustrates a case where a B1 block has been selected from the merge candidate list. In this case, an “index 1 (Index 1)” may be signaled to the decoder as a merge index.

The decoder configures a merge candidate list like the encoder, and derives motion information about a current prediction block from motion information of a candidate block corresponding to a merge index from the encoder in the merge candidate list. Furthermore, the decoder generates a prediction block for a current processing block based on the derived motion information (i.e., motion compensation).

2) Advanced Motion Vector Prediction (AMVP) Mode

The AMVP mode means a method of deriving a motion vector prediction value from a neighbor block. Accordingly, a horizontal and vertical motion vector difference (MVD), a reference index and an inter-prediction mode are signaled to the decoder. Horizontal and vertical motion vector values are calculated using the derived motion vector prediction value and a motion vector difference (MVDP) provided by the encoder.

That is, the encoder configures a motion vector predictor candidate list, and signals a motion reference flag (i.e., candidate block information) (e.g., mvp_IX_flag[x0][y0]′), selected in motion vector predictor candidate list by performing motion estimation, to the decoder. The decoder configures a motion vector predictor candidate list like the encoder, and derives the motion vector predictor of a current processing block using motion information of a candidate block indicated by a motion reference flag received from the encoder in the motion vector predictor candidate list. Furthermore, the decoder obtains a motion vector value for the current processing block using the derived motion vector predictor and a motion vector difference transmitted by the encoder. Furthermore, the decoder generates a prediction block for the current processing block based on the derived motion information (i.e., motion compensation).

In the case of the AMVP mode, two spatial motion candidates of the five available candidates in FIG. 7 are selected. The first spatial motion candidate is selected from a {A0, A1} set located on the left side, and the second spatial motion candidate is selected from a {B0, B1, B2} set located at the top. In this case, if the reference index of a neighbor candidate block is not the same as a current prediction block, a motion vector is scaled.

If the number of candidates selected as a result of search for spatial motion candidates is 2, a candidate configuration is terminated. If the number of selected candidates is less than 2, a temporal motion candidate is added.

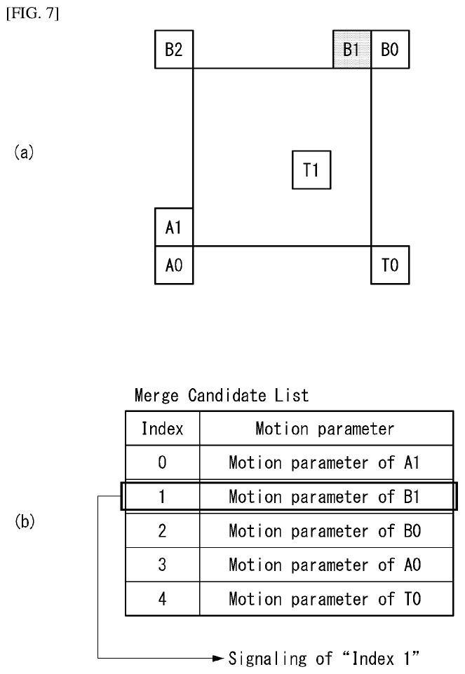

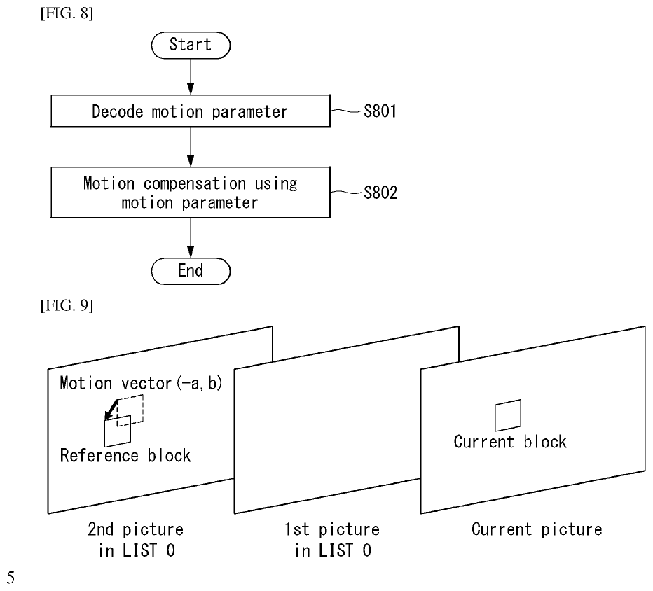

FIG. 8 is an embodiment to which the disclosure is applied and is a diagram illustrating an inter-prediction method.

Referring to FIG. 8, the decoder (in particular, the inter-prediction unit 261 of the decoder in FIG. 2) decodes a motion parameter for a processing block (e.g., a prediction unit) (S801).

For example, if the merge mode has been applied to the processing block, the decoder may decode a merge index signaled by the encoder. Furthermore, the motion parameter of the current processing block may be derived from the motion parameter of a candidate block indicated by the merge index.

Furthermore, if the AMVP mode has been applied to the processing block, the decoder may decode a horizontal and vertical motion vector difference (MVD), a reference index and an inter-prediction mode signaled by the encoder. Furthermore, the decoder may derive a motion vector predictor from the motion parameter of a candidate block indicated by a motion reference flag, and may derive the motion vector value of a current processing block using the motion vector predictor and the received motion vector difference.

The decoder performs motion compensation on a prediction unit using the decoded motion parameter (or information) (S802).

That is, the encoder/decoder perform motion compensation in which an image of a current unit is predicted from a previously decoded picture using the decoded motion parameter.

FIG. 9 is an embodiment to which the disclosure may be applied and is a diagram illustrating a motion compensation process.

FIG. 9 illustrates a case where a motion parameter for a current block to be encoded in a current picture is uni-direction prediction, a second picture within LIST0, LIST0, and a motion vector (−a, b).

In this case, as in FIG. 9, the current block is predicted using the values (i.e., the sample values of a reference block) of a location (−a, b) spaced apart from the current block in the second picture of LIST0.

In the case of bi-directional prediction, another reference list (e.g., LIST1), a reference index and a motion vector difference are transmitted. The decoder derives two reference blocks and predicts a current block value based on the two reference blocks.

Method of Processing an Image Based on Inter Prediction Mode

In inter prediction, in order to effectively reduce the amount of motion information, a merge mode using motion information of spatially or temporally neighboring blocks is used. In the merge mode, motion information (prediction direction, reference picture index or motion vector prediction value) is derived based on only a merge flag and a merge index.

A conventional merge mode has a disadvantage in that various characteristics of images are not incorporated because motion information of limited candidate blocks is used. Particularly, since candidates are listed according to a predetermined sequence, a specific candidate block may not be selected due to the amount of bits allocated to a merge index although the motion accuracy of the specific candidate block is high or a candidate having a relatively small amount of bits may be selected. In other words, a candidate may not be included in a merge candidate list or relatively many bits may be allocated depending on the configuration sequence of a list despite a high motion accuracy of the candidate. As a result, compression efficiency may be degraded.

Accordingly, the disclosure proposes a method of grouping merge candidates in order to solve such problems and effectively configure merge candidates.

According to a method proposed in the disclosure, the number of merge candidates can be effectively increased compared to the existing merge mode. The probability of selecting temporally neighboring blocks or combined merge candidates in addition to spatially neighboring blocks in the existing merge mode may be increased. A candidate not selected due to a relatively large amount of bits may be selected, and compression efficiency may be improved by configuring a merge candidate list using a candidate not included in a list because the candidate has a relatively lower priority.

### Embodiment 1

In an embodiment of the disclosure, the encoder/decoder may generate a merge candidate list using the motion vectors of various candidate blocks by grouping merge candidates.

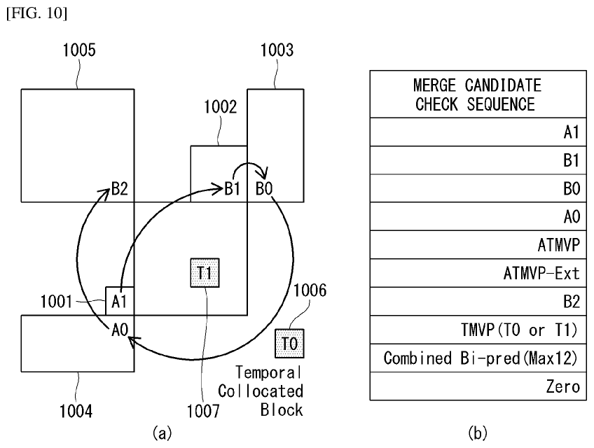

FIG. 10 is an embodiment to which the disclosure is applied, and is a diagram for describing a method of generating a merge candidate list using a spatial neighbor block or temporal neighbor block.

Referring to FIG. 10, the encoder/decoder may configure a merge candidate list according to a predetermined sequence until a maximum number is satisfied using motion information of a spatially or temporal neighbor block or motion information of a combination of the motion information. For example, the encoder/decoder may configure a merge candidate list by searching for (or checking) a merge candidate according to the following sequence.
A1(1001), B1(1002), B0(1003), A0(1004), ATMVP(Advanced Temporal Motion Vector Predictor), ATMVP-Ext(ATMVP-ext: Advanced Temporal Motion Vector Predictor-extension), B2(1005), TMVP (i.e., T0(1006) or T1(1007)), a combined merge candidate, a zero motion vector

The encoder/decoder may configure a merge candidate list by searching for candidates according to the above sequence and adding candidates corresponding to a predetermined number. Furthermore, the encoder/decoder may assign merge indexes according to the sequence with respect to respective candidates within a merge candidate list, and may code/decode the candidates.

As described above, there may be a problem in that a specific candidate block may not be selected by considering the amount of bits allocated to a merge index although the motion accuracy of the specific candidate block is high because candidates are listed based on a predetermined number and sequence.

Furthermore, the motion vector of a spatially neighboring block is added (or listed) as a merge candidate, the motion vector of a temporally neighboring block and a combined motion vector are subsequently added as the merge candidates. Hereinafter, the combined motion vector may be referred to as a combined merge candidate or a combined bi-predictive merging candidate.

The motion vector of the temporally neighboring block and the combined motion vector have a problem in that signaling overhead is great because the motion vectors have a good possibility that they may be disposed in a merge candidate list with a relatively lower priority. Furthermore, even though changing the sequence of candidates or increasing the number of candidates in order to solve such a problem, there is a limit to performance improvement.

Accordingly, the disclosure proposes a method of grouping merge candidates in order to solve such problems and increase the number of merge candidates.

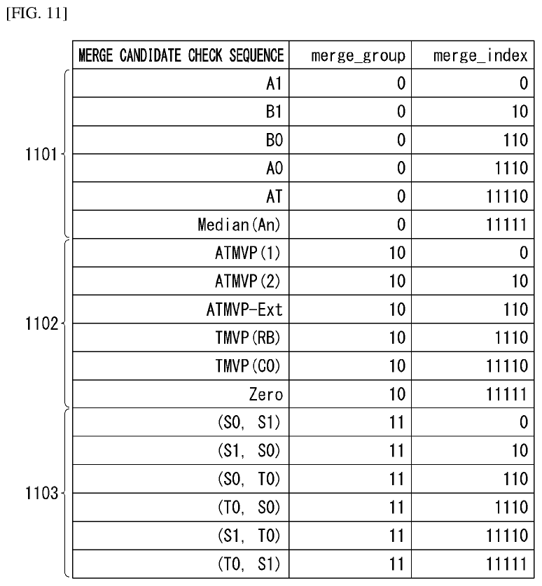

FIG. 11 is an embodiment to which the disclosure is applied, and is a diagram illustrating a method of grouping merge candidates.

Referring to FIG. 11, the encoder/decoder may classify the motion vectors of spatially neighboring blocks, the motion vectors of temporally neighboring blocks, and motion vectors generated in combination, and may generate merge candidate groups (or a merge candidate group list) including the motion vectors. In this case, it is assumed that each of three groups illustrated in FIG. 11 is configured with six candidates, but the disclosure is not limited thereto. The number of candidates of each group may be changed. Furthermore, in FIG. 11, candidates of each group and the sequence of the candidates may be changed.

The encoder/decoder may generate a first candidate group 1101 including the motion vectors of spatial neighbor blocks, a second candidate group 1102 including the motion vectors of temporal neighbor blocks, and a third candidate group 1103 including combined merge candidates, that is, combinations of the motion vectors of candidates of the first candidate group and/or the second candidate group.

As described above, in a conventional merge mode, there is a good possibility that temporal merge candidates or combined merge candidates are positioned with a relatively lower priority within a list or may not be included in the list. In contrast, in the present embodiment, the probability that a temporal merge candidate or a combined merge candidate will be selected as a merge candidate can be increased because the temporal merge candidate or combined merge candidate is included in the second candidate group 1102 or the third candidate group 1103.

Furthermore, the motion vectors of spatial neighbor blocks statistically have a relatively high selection rate. Accordingly, the encoder/decoder may differently set bits assigned to candidate groups by considering the selection probability of the motion vector of a candidate block or the accuracy of motion information.

For example, the encoder/decoder may signal, as “0” (i.e., assign one bit), the first candidate group 1101 including the motion vectors of spatial neighbor blocks having a relatively high selection rate, and may signal the second candidate group 1102 and the third candidate group 1103 as “10” and “11” (i.e., assign two bits), respectively. The number of candidates of each group may be efficiently increased by grouping merge candidates. Temporal merge candidates and combined merge candidates may be signaled using a relatively small amount of bits.

Various merge candidates which may be included in each candidate group, including the merge candidates (i.e., AT, Median(An), ATMVP(1), ATMVP(2), ATMVP-ext, TMVP(RB), TMVP(C0), (S0, S1), (S1, S0), (S0, T0)) illustrated in FIG. 11, is specifically described below.

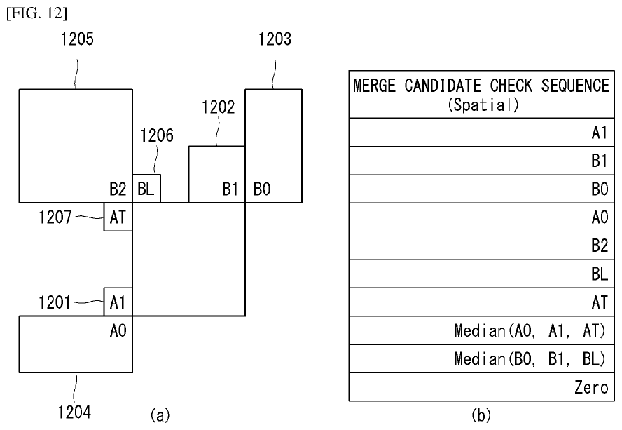

FIG. 12 is an embodiment to which the disclosure is applied, and is a diagram for describing a method of configuring a merge candidate group using the motion vectors of spatial neighbor blocks.

As illustrated in FIG. 12(a), the encoder/decoder may generate a first candidate group using the motion vectors of various spatial neighbor blocks of a current block. In this case, the encoder/decoder may check candidates in a sequence illustrated in FIG. 12(b), and may add the candidates to the candidate group (or candidate group list). In other words, the encoder/decoder may check whether each candidate is available in a check sequence, such as that illustrated in FIG. 12(b), and may add a candidate to the candidate group when the candidate is available.

Specifically, the first candidate group may include the motion vectors of a block (or bottom left block) 1201 including a pixel horizontally neighboring the bottom left pixel of a current block, a block (or top right block) 1202 including a pixel vertically neighboring the top right pixel of the current block, a block (or above right block) 1203 including a pixel diagonally neighboring the top right pixel of the current block, a block (or below left block) 1204 including a pixel diagonally neighboring the bottom left pixel of the current block, a block (or above left block) 1205 including a pixel diagonally neighboring the top left pixel of the current block, a block (or top left block) 1206 including a pixel vertically neighboring the top left pixel of the current block, and a block (or top left block) 1207 including a pixel horizontally neighboring the top left pixel of the current block.

Furthermore, the first candidate group may include the median (Median(A0, A1, AT)) of the left blocks (i.e., the bottom left block 1201, the below left block 1204, and the top left block 1207), and may include the median (Median(B0, B1, BL)) of the above blocks (i.e., the above right block 1203, the top right block 1202, the top left block 1206).

In one embodiment, the encoder/decoder may add a zero motion vector when the first candidate group is not filled with candidates as many as the first candidate group needs, and may perform pruning for removing a redundant candidate when candidates have same motion information.

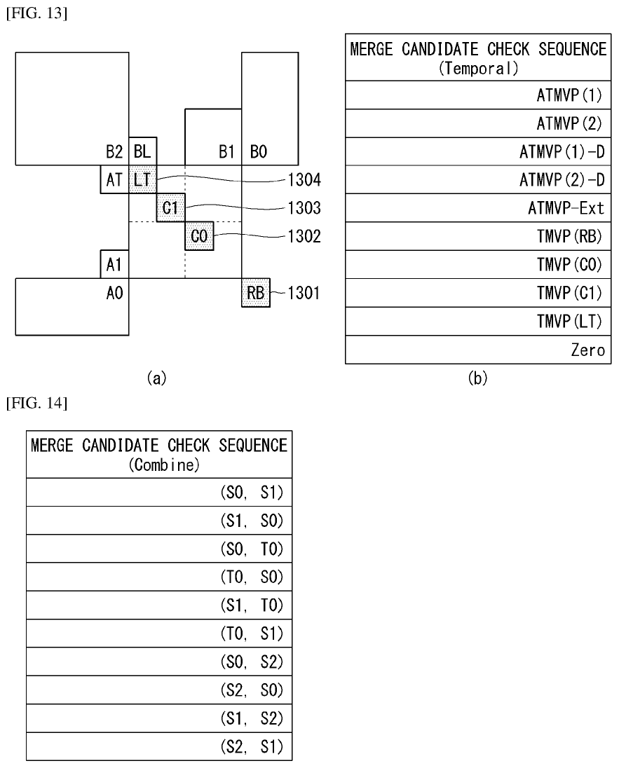

FIG. 13 is an embodiment to which the disclosure is applied, and is a diagram for describing a method of configuring a merge candidate group using the motion vectors of temporally neighboring blocks.

As illustrated in FIG. 13(a), the encoder/decoder may generate a second candidate group using the motion vectors of various temporal neighbor blocks of a current block. In this case, the encoder/decoder may check candidates in a sequence, such as that illustrated in FIG. 13(b), and may add the candidates to the candidate group (or candidate group list). In other words, the encoder/decoder may check whether each candidate is available in a check sequence, such as that illustrated in FIG. 13(b), and may add a candidate to the candidate group when the candidate is available.

The encoder/decoder may add, to a candidate group, motion information of reference blocks specified by motion information of neighbor blocks of a current block within a reference picture (hereinafter referred to as a temporal candidate picture) for a temporal merge candidate. That is, the encoder/decoder may add an advanced temporal motion vector predictor (ATMVP) and an advanced temporal motion vector predictor-extension (ATMVP-ext) to a second candidate group.

The encoder/decoder may use the motion vectors of reference blocks specified using the motion vectors of one or more spatial candidate blocks. In FIG. 13, a case where two ATMVPs are used is assumed. In this case, the ATMVP(1) indicates a candidate using motion information of a reference block specified by the motion vector of a spatial merge candidate which is first added to a list. The ATMVP(2) indicates a candidate using motion information of a reference block specified by the motion vector of a spatial merge candidate which is second added to the list.

Furthermore, each of an ATMVP(1)-D and ATMVP(2)-D indicates the default motion vector of a corresponding reference block. That is, in applying an ATMVP, the encoder/decoder may derive motion information of a reference block in a current processing block unit, and may derive motion information of a reference block in a subblock (e.g., 4×4 block) unit. In order to derive a motion vector prediction value in a coding block (or transform block) unit, the encoder/decoder may use only a default motion vector like the ATMVP(1)-D or the ATMVP(2)-D. The default motion vector may be motion information at a specific location of a reference block. For example, the default motion vector may be motion information at the top left location or motion information at the middle location of a reference block.

Furthermore, the encoder/decoder may add, to a second candidate group, an ATMVP-Ext which uses an average value or median of the motion vectors of blocks spatially and/or temporally neighboring with respect to each subblock of a current block.

Furthermore, the encoder/decoder may add, to the second candidate group, the motion vectors of blocks at locations corresponding to a current block within a temporal candidate picture. The locations corresponding to the current block may be the locations of a block (or below right neighbor block) 1301 including a pixel corresponding to a pixel diagonally neighboring a below right pixel of a current block, a block (or middle below right block) 1302 including a pixel corresponding to a below right pixel at the middle location of the current block, a block (or middle above left block) 1303 including a pixel corresponding to an above left pixel at the middle location of the current block, and a block (or top left block) 1304 including a pixel corresponding to the top left pixel of the current block, for example.

In one embodiment, the encoder/decoder may add a zero motion vector the second candidate group is not filled with candidates as many as the second candidate group needs, and may perform pruning for removing a redundant candidate when candidates have same motion information.

FIG. 14 is an embodiment to which the disclosure is applied, and is a diagram for describing a method of configuring a merge candidate group using combined merge candidates.

Referring to FIG. 14, the encoder/decoder may generate a third candidate group using various combined motion vectors which combine the motion vectors of spatial neighbor blocks and/or the motion vectors of temporal neighbor blocks. For example, the encoder/decoder may check combined merge candidates in a sequence, such as that illustrated in FIG. 14, and may add the combined merge candidates to a candidate group (or candidate group list). In other words, the encoder/decoder may check whether each candidate is available in a check sequence, such as that illustrated in FIG. 14, and may add a candidate to the candidate group when the candidate is available.

For example, the encoder/decoder may add, to the third candidate group, combined merge candidates having several combinations configured with the motion vectors S0, S1, and S2 of spatial neighbor blocks and the motion vector T0 of a temporal neighbor block, such as those illustrated in FIG. 14. In this case, S0, S1, S2 indicate the spatial merge candidates that are respectively first, second, and third added to the candidate group (or candidate list). Furthermore, T0 indicates a temporal merge candidate first added to the candidate group.

In one embodiment, if the motion vectors of spatial neighbor blocks and the motion vectors of temporal neighbor blocks are listed like {S0, S1, T0, S2}, the encoder/decoder may configure combined merge candidates as illustrated in FIG. 14. In this case, the number and sequence of spatial merge candidates and temporal merge candidates for the combined merge candidates may be changed. Preferably, the encoder/decoder may configure combined merge candidates by combining two or three spatial merge candidates and one temporal merge candidate.

Furthermore, the encoder/decoder may combine spatial merge candidates and/or temporal merge candidates using various methods. For example, the encoder/decoder may configure a combined candidate based on the average of the motion vectors of two merge candidates, and may configure a combined candidate based on a bi-direction motion vector using the motion vectors of two merge candidates as the motion vectors of an L0 direction and L1 direction, respectively. The encoder/decoder may apply scaling based on the distances from reference pictures when the reference pictures of combined merge candidates are different.

Furthermore, in one embodiment, the encoder/decoder may add a zero motion vector when third candidate group is not filled with candidates as many as the third candidate group needs, and may perform pruning for removing a redundant candidate when candidates have same motion information.

### Embodiment 2

The motion vectors of spatial neighbor block have relatively higher accuracy in motion prediction than the motion vectors of temporal neighbor blocks, and are statistically more selected than the motion vectors of the temporal neighbor blocks. According to the method described in Embodiment 1, there is a problem in that signaling for a group index is necessary in any case although the selection rate of the motion vectors of spatial neighbor blocks is high.

In order to improve such a problem, an embodiment of the disclosure proposes a method of obviating group index signaling overhead for specific candidates having a high selection rate by grouping the remaining merge candidates other than the motion vectors of the specific spatial neighbor blocks.

The encoder/decoder may group the remaining candidates other than a specific spatial merge candidate, and may allocate a group index to each candidate group. The encoder/decoder may group the remaining candidates into a plurality of groups. For example, according to the method described in Embodiment 1, the encoder/decoder may group the remaining candidates other than the specific spatial merge candidates into three merge candidate groups. Alternatively, for example, the encoder/decoder may group the remaining candidates other than the specific spatial merge candidates into two merge candidate groups. This is described below with reference to the following drawing.

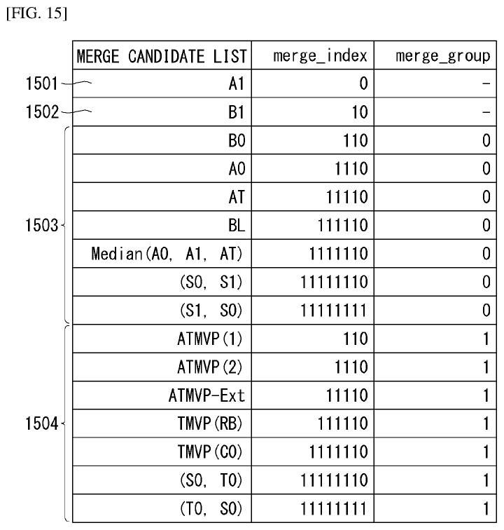

FIG. 15 is an embodiment to which the disclosure is applied, and is a diagram illustrating a method of grouping merge candidates.

Referring to FIG. 15, the encoder/decoder may group the remaining candidates except the A1 candidate 1501 and the B1 candidate 1502. The encoder/decoder may generate a first candidate group 1503 including the motion vectors of spatial neighbor blocks and a second candidate group 1504 including the motion vectors of temporal neighbor blocks from the remaining merge candidates.

In this case, a group index is not allocated to the A1 candidate 1501 and the B1 candidate 1502 because group index signaling for the A1 candidate 1501 and the B1 candidate 1502 is not performed. The encoder/decoder may allocate a syntax bit of 1 bit for signaling a group index for the first candidate group 1503 and the second candidate group 1504. In the method described in Embodiment 1, maximum 2 bits are used for group index signaling. In contrast, according to a method proposed in the present embodiment, group index signaling can be performed using 1 bit.

In one embodiment, the decoder may first parse a merge index, and may determine whether to parse a merge group index based on the parsed merge index. For example, when the parsed merge index has a value of “0” or “10”, the decoder may recognize that a corresponding merge candidate does not belong to a candidate group to which a group index is assigned, and may determine a merge candidate without additionally parsing the group index. Meanwhile, when the parsed merge index has a value greater than “10”, the decoder may determine whether a corresponding merge candidate is the first candidate group 1503 or the second candidate group 1504 by additionally parsing the group index, and may finally determine a merge candidate.

Furthermore, the first candidate group 1503 may include a combined merge candidate using the motion vector of a spatial merge candidate. The second candidate group 1504 may include a combined merge candidate including the motion vector of a spatial merge candidate and/or the motion vector of a temporal merge candidate. Merge candidates which may be included in the candidate groups are specifically described below.

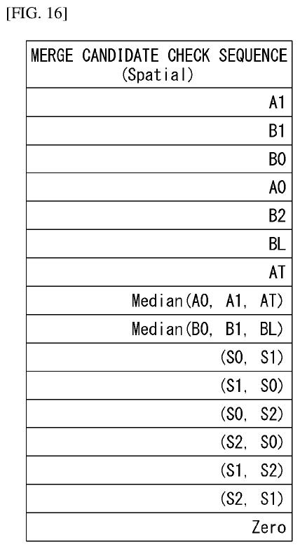

FIG. 16 is a diagram illustrating a method of configuring a merge candidate group using the motion vectors of spatially neighboring blocks according to an embodiment of the disclosure.

The encoder/decoder may generate a first candidate group using the motion vectors of various spatial neighbor blocks of a current block. In this case, the encoder/decoder may check candidates in a sequence, such as that illustrated in FIG. 16, and may add the candidates to the candidate group (or candidate group list). In other words, the encoder/decoder may check whether each candidate is available in a check sequence, such as that illustrated in FIG. 16, and may add a candidate to the first candidate group when the candidate is available. In this case, candidates for configuring the first candidate group or the number and sequence of candidates may be changed.

The first candidate group may include the median (Median(A0, A1, AT)) of the motion vectors of left blocks and the median (Median(B0, B1, BL)) of the motion vectors of top blocks in addition to the motion vectors of the blocks neighboring the left and top of a current block as shown in FIG. 12. Furthermore, the first candidate group may include a combined merge candidate, that is, a combination of motion vectors in L0 and L1 directions based on previously filled candidates Sn(n=0, 1, 2).

Furthermore, in one embodiment, the encoder/decoder may add a zero motion vector when the first candidate group is not filled with candidates as many as the first candidate group needs, and may perform pruning for removing a redundant candidate when candidates have same motion information.

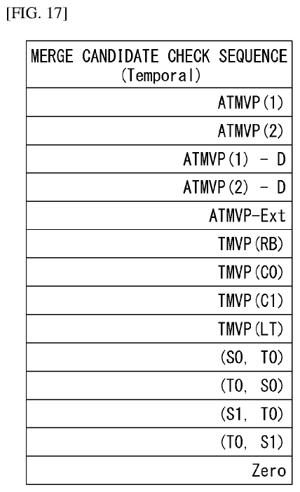

FIG. 17 is a diagram illustrating a method of configuring a merge candidate group using the motion vectors of temporally neighboring blocks according to an embodiment of the disclosure.

The encoder/decoder may generate a second candidate group using the motion vectors of various temporal neighbor blocks of a current block. In this case, the encoder/decoder may check candidates in a sequence, such as that illustrated in FIG. 17, and may add the candidates to the candidate group (or candidate group list). In other words, the encoder/decoder may check whether each candidate is available in a check sequence, such as that illustrated in FIG. 17, and may add a candidate to the second candidate group when the candidate is available. In this case, candidates for configuring the second candidate group or the number and sequence of candidates may be changed.

The encoder/decoder may add, to a candidate group, motion information of a reference block, specified by motion information of a neighbor block of a current block, within a temporal candidate picture. That is, the encoder/decoder may add an ATMVP or an ATMVP-ext to the second candidate group.

Furthermore, the encoder/decoder may use the motion vectors of reference blocks specified using the motion vectors of one or more spatial candidate blocks. In FIG. 17, a case where two ATMVPs are used is assumed. In this case, the ATMVP(1) indicates a candidate using motion information of a reference block specified by the motion vector of a spatial merge candidate first added to a list. The ATMVP(2) indicates a candidate using motion information of a reference block specified by the motion vector of a spatial merge candidate second added to the list.

Furthermore, each of an ATMVP(1)-D and an ATMVP(2)-D indicates the default motion vector of a corresponding reference block. That is, in applying the ATMVP, the encoder/decoder may derive motion information of a reference block in a current processing block unit, and may derive motion information of a reference block in a subblock (e.g., 4×4 block) unit. In order to derive a motion vector prediction value in a coding block (or transform block), the encoder/decoder may use only a default motion vector like the ATMVP(1)-D or the ATMVP(2)-D. The default motion vector may be motion information at a specific location of a reference block. For example, the default motion vector may be motion information at the top left location or motion information at the middle location of a reference block.

Furthermore, the encoder/decoder may add, to the second candidate group, an ATMVP-Ext using an average value or median of the motion vectors of blocks spatially and/or temporally neighboring with respect to each subblock of a current block.

Furthermore, the encoder/decoder may add, to the second candidate group, the motion vectors of blocks at locations corresponding to a current block within a temporal candidate picture. The locations corresponding to the current block may be the locations of a block (or below right neighbor block) including a pixel corresponding to a pixel diagonally neighboring a below right pixel of the current block, a block (or a middle below right block) including a pixel corresponding to a below right pixel at the middle location of the current block, a block (or a middle above left block) including a pixel corresponding to an above left pixel at the middle location of the current block, and a block (or a top left block) including a pixel corresponding to the top left pixel of the current block, for example.

Furthermore, the second candidate group may include a combined merge candidate, that is, a combination of the motion vectors of a spatially neighboring block and temporally neighboring block. FIG. 17 illustrates combined merge candidates, that is, combinations of the motion vector of spatially neighboring blocks S0 and S1 and the motion vector of a temporally neighboring block T0. The number of combined merge candidates included in the check sequence of the second candidate group may be changed. A combination, number and sequence of the motion vectors of spatial neighbor blocks and/or temporal neighbor blocks combined for a combined merge candidate may be changed.

Furthermore, in one embodiment, the encoder/decoder may add a zero motion vector when the second candidate group is not filled with candidates as many as the second candidate group needs, and may perform pruning for removing a redundant candidate when candidates have same motion information.

### Embodiment 3

An embodiment of the disclosure proposes a method of effectively applying Embodiment 1 or Embodiment 2. The encoder/decoder may configure an effective candidate list by setting various restriction conditions.

In an embodiment of the disclosure, the encoder/decoder may determine whether to code a syntax for signaling a merge candidate group based on a slice form of a reference picture. If the reference picture of a current block is a slice (or picture) coded as an intra prediction (or intraframe prediction), a temporal merge candidate cannot be derived. In this case, if candidate groups are configured using the method proposed in Embodiment 1 or Embodiment 2, there is a problem in that an unnecessary bit is wasted because one bit must be transmitted in order to signal a candidate group including spatial merge candidates.

Accordingly, the encoder/decoder may confirm whether a reference picture is a slice coded through an intra prediction before configuring a candidate group. If the reference picture is a slice coded through an intra prediction, the encoder/decoder may configure a merge candidate list using the motion vectors of spatial neighbor blocks and a combination of them without grouping merge candidates. Accordingly, signaling overhead attributable to a group index can be reduced if a reference picture is an intra slice.

Furthermore, in an embodiment of the disclosure, the encoder/decoder may perform a redundancy check when configuring candidate groups. That is, when a candidate is checked, candidates having same motion information may be removed. In this case, the encoder/decoder may perform the redundancy check within each candidate group only, and may perform the redundancy check on all candidate groups.

For example, when configuring a candidate group including temporal merge candidates, the encoder/decoder may remove a candidate having redundant motion information by performing a redundancy check for spatial merge candidates. Furthermore, when configuring a candidate group including combined merge candidates, the encoder/decoder may remove a candidate having redundant motion information by performing a redundancy check for spatial merge candidates and temporal merge candidates.

Meanwhile, although candidates belonging to different groups have same motion information, the amount of allocated bits may be different depending on a sequence within a corresponding group. In this case, a candidate having redundant motion information may be considered to have relatively higher motion accuracy than a candidate not having redundant motion information. Accordingly, if a redundancy check for a different candidate group is performed, the encoder/decoder may perform a redundancy check by considering the amount of allocated bits. That is, in performing a redundancy check for a previously configured candidate group, the encoder/decoder may compare a sequence of a redundant candidate within the previous group with a sequence of the redundant candidate within a current group. If, as a result of the comparison, the sequence within the current group is not earlier than the sequence within the previous group, the encoder/decoder may remove the redundant candidate.

For example, if motion information of a candidate to which a merge index value of 4 has been assigned in a first candidate group and motion information of a candidate to which a merge index value of 0 has been assigned in a second candidate group are the same, the encoder/decoder may not remove the corresponding candidate from the second candidate group.

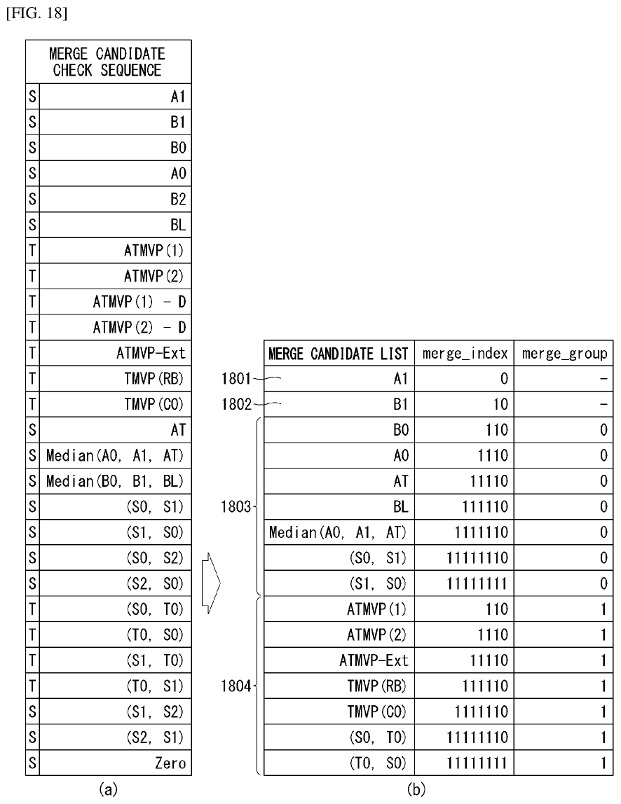

FIG. 18 is an embodiment to which the disclosure is applied, and is a diagram for describing a method of checking merge candidates in order to configure a merge candidate group.

The encoder/decoder may check candidates in a sequence, such as that illustrated in FIG. 18(a), and may configure a candidate group. In other words, the encoder/decoder may previously set the check sequence of all the candidates not classified for each group. Furthermore, the encoder/decoder may add available candidates to a candidate list while checking candidates according to a preset sequence. In this case, the encoder/decoder may perform a redundancy check on previously checked candidates.

If the method described in Embodiment 2 is applied, the encoder/decoder may first check the A1 candidate 1801 and the B1 candidate 1802, and may add the candidates to a merge candidate list. Thereafter, the encoder/decoder may check candidates according to a next sequence, and may configure a first candidate group 1803 and a second candidate group 1804. A checked sequence is important because the sequence that merge candidates are configured and the allocation of a merge index are changed depending on the check sequence of each candidate and a redundancy check condition. The encoder/decoder may determine the check sequence of each candidate based on a specific sequence without classifying the candidates for each group.

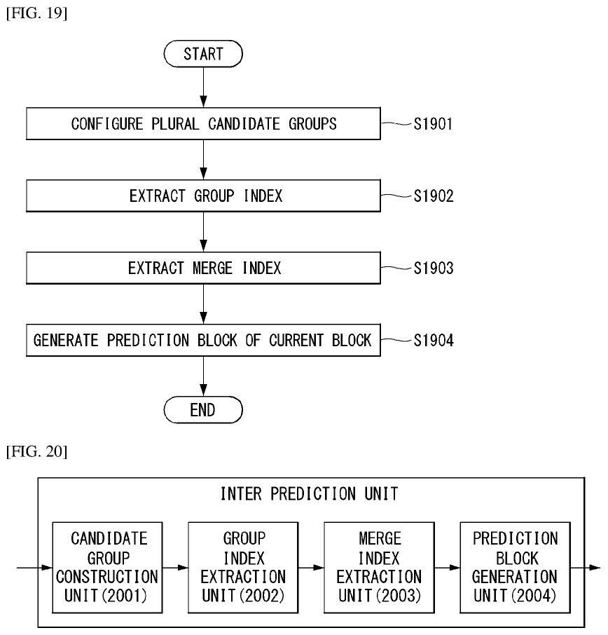

FIG. 19 is a diagram for describing an inter prediction method according to an embodiment of the disclosure.

Referring to FIG. 19, the decoder is basically described, for convenience of description, but an inter prediction method according to the present embodiment may be identically applied to the encoder and the decoder.

The decoder checks merge candidates according to a predetermined sequence and configures a plurality of candidate groups (S1901).

As described above, the decoder may classify the motion vectors of spatially neighboring blocks, the motion vectors of temporally neighboring blocks, and motion vectors generated in combination, and may generate merge candidate groups each including motion vectors. The plurality of candidate groups may include a first candidate group including motion information of spatial neighbor blocks of a current block, and a second candidate group including motion information of temporal neighbor blocks of the current block. Furthermore, the plurality of candidate groups may further include a third candidate group including combined merge candidates, that is, a combination of the motion vectors of the candidates of the first candidate group or the second candidate group.

As described above, the decoder may differently set bits allocated to the candidate groups by considering the selection probability of the motion vector of a candidate block or the accuracy of motion information. The decoder may allocate less bits to a group index indicating a first candidate group, including the motion vectors of spatially neighboring blocks having a relatively high selection rate, than to a group index indicating a second candidate group.

As described in FIG. 12, the decoder may add, to the first candidate group, at least one of the motion vector of a block including a pixel horizontally or vertically neighboring the top left pixel of a current block, the median of the motion vectors of blocks neighboring the left side of the current block or the median of the motion vectors of blocks neighboring the upper side of the current block.

As described in FIG. 13, the decoder may add, to the second candidate group, the advanced temporal motion vector predictor (ATMVP) and the advanced temporal motion vector predictor-extension (ATMVP-ext).

That is, the second candidate group may include a first advanced temporal merge candidate using, as a subblock unit, a motion vector of a reference block specified by the motion vector of a specific merge candidate of the first candidate group, and a second advanced temporal merge candidate using, as a subblock unit, an average value or median of the motion vectors of spatial neighbor blocks and temporal neighbor blocks of the current block.

Furthermore, as described above, the decoder may use only a default motion vector, like an ATMVP(1)-D or an ATMVP(2)-D, in order to derive a motion vector prediction value in a coding block (or transform block) unit. That is, the second candidate group may include a third advanced temporal merge candidate using a motion vector at the top left location or middle location of a reference block specified by the motion vector of a specific merge candidate of the first candidate group.

Furthermore, as described above, the decoder may add, to the second candidate group, the motion vectors of blocks at locations corresponding to the current block within a temporal candidate picture. The locations corresponding to the current block may be the below right neighbor block, middle below right block, middle above left block, and top left block location of the current block, for example. That is, the second candidate group may include the motion vector of a block including a pixel corresponding to the above left pixel at the middle location of the current block or a block including a pixel corresponding to the top left pixel of the current block, within the temporal candidate picture.

The decoder extracts a group index indicating a specific candidate group among the plurality of candidate groups (S1902).

As described above, the decoder may not parse a group index with respect to a specific spatial neighbor block (or a specific spatial merge candidate). Furthermore, the decoder may group the remaining candidates other than the specific spatial merge candidate into two merge candidate groups. In this case, step S1902 may include the step of determining whether to extract (or parse) the group index based on a merge index value. Furthermore, the decoder may extract a group index indicating a specific candidate group among the plurality of candidate groups based on a result of the determination of the extraction. In this case, whether to extract the group index may be determined based on whether the merge index value exceeds a preset value.

Furthermore, as described above, the decoder may determine whether to decode a syntax for signaling a merge candidate group based on a slice form of a reference picture. That is, the decoder may confirm whether the reference picture of a current block corresponds to a slice coded through an intra prediction. Furthermore, if, as a result of the confirmation, the reference picture of the current block does not correspond to a slice coded through an intra prediction, the decoder may extract a group index indicating a specific candidate group among the plurality of candidate groups.

The decoder extracts a merge index indicating a specific merge candidate within the candidate group indicated by the group index (S1903).

As described above, the decoder may first parse the merge index and determine whether to parse a merge group index based on the parsed merge index. In this case, step S1903 may be performed prior to step S1902.

The decoder generates a prediction block of the current block using motion information of a merge candidate indicated by the merge index (S1904).

FIG. 20 is a diagram more specifically illustrating an inter prediction unit according to an embodiment of the disclosure.

In FIG. 20, the inter prediction unit has been illustrated as a block, for convenience of description, but the intra prediction unit may be implemented as an element included in the encoder and/or the decoder.

Referring to FIG. 20, the inter prediction unit implements the functions, functions and/or methods proposed in FIGS. 5 to 19. Specifically, the inter prediction unit may be configured to include a candidate group construction unit 2001, a group index extraction unit 2002, a merge index extraction unit 2003, and a prediction block generation unit 2004.

The candidate group construction unit 2001 checks merge candidates according to a predetermined sequence and configures a plurality of candidate groups.

As described above, the candidate group construction unit 2001 may classify the motion vectors of spatially neighboring blocks, the motion vectors of temporally neighboring blocks, and motion vectors generated in combination, and may generate merge candidate groups each including motion vectors. The plurality of candidate groups may include a first candidate group including motion information of spatial neighbor blocks of a current block, and a second candidate group including motion information of temporal neighbor blocks of the current block. Furthermore, the plurality of candidate groups may further include a third candidate group including combined merge candidates, that is, combinations of the motion vectors of the candidates of the first candidate group or the second candidate group.

As described above, the candidate group construction unit 2001 may differently set bits allocated to candidate groups by considering the selection probability of the motion vector of a candidate block or the accuracy of motion information. The candidate group construction unit 2001 may allocate less bits to a group index indicating a first candidate group, including the motion vectors of spatially neighboring blocks having a relatively high selection rate, than to a group index indicating a second candidate group.

As described in FIG. 12, the candidate group construction unit 2001 may add, to the first candidate group, at least one of the motion vectors of blocks including a pixel horizontally or vertically neighboring the left pixel or the top pixel of a current block and the median of the motion vectors of blocks neighboring the left of the current block or the median of the motion vectors of blocks neighboring the top of the current block.

As described in FIG. 13, the candidate group construction unit 2001 may add, to the second candidate group, an advanced temporal motion vector predictor (ATMVP) and an advanced temporal motion vector predictor-extension (ATMVP-ext).

That is, the second candidate group may include a first advanced temporal merge candidate using, as a subblock unit, a motion vector of a reference block specified by the motion vector of a specific merge candidate of the first candidate group, and a second advanced temporal merge candidate using, as a subblock unit, an average value or median of the motion vectors of spatial neighbor blocks and temporal neighbor blocks of the current block.

Furthermore, as described above, the candidate group construction unit 2001 may use only a default motion vector, like an ATMVP(1)-D or an ATMVP(2)-D, in order to derive a motion vector prediction value in a coding block (or transform block) unit. That is, the second candidate group may include a third advanced temporal merge candidate using a motion vector at the top left location or middle location of a reference block specified by the motion vector of a specific merge candidate of the first candidate group.

Furthermore, as described above, the candidate group construction unit 2001 may add, to the second candidate group, the motion vectors of blocks at locations corresponding to the current block within a temporal candidate picture. The locations corresponding to the current block may be the below right neighbor block, middle below right block, middle above left block, and top left block location of the current block, for example. That is, the second candidate group may include the motion vector of a block including a pixel corresponding to the above left pixel at the middle location of the current block or a block including a pixel corresponding to the top left pixel of the current block within the temporal candidate picture.

The group index extraction unit 2002 extracts a group index indicating a specific candidate group among the plurality of candidate groups.

As described above, the decoder may not parse a group index with respect to a specific spatial neighbor block (or a specific spatial merge candidate). Furthermore, the decoder may group the remaining candidates other than the specific spatial merge candidate into two merge candidate groups. In this case, the group index extraction unit 2002 may determine whether to extract (or parse) the group index based on a merge index value. Furthermore, the group index extraction unit 2002 may extract a group index indicating a specific candidate group among the plurality of candidate groups based on a result of the determination of the extraction. In this case, whether to extract the group index may be determined based on whether the merge index value exceeds a preset value.

Furthermore, as described above, the decoder may determine whether to decode a syntax for signaling a merge candidate group based on a slice form of a reference picture. That is, the decoder may confirm whether the reference picture of a current block corresponds to a slice coded through an intra prediction. Furthermore, if, as a result of the confirmation, the reference picture of the current block does not correspond to a slice coded through an intra prediction, the group index extraction unit 2002 may extract a group index indicating a specific candidate group among the plurality of candidate groups.

The merge index extraction unit 2003 extracts a merge index indicating a specific merge candidate within the candidate group indicated by the group index.

As described above, the decoder may first parse the merge index and determine whether to parse a merge group index based on the parsed merge index.

The prediction block generation unit 2004 generates a prediction block of the current block using motion information of a merge candidate indicated by the merge index.

In the aforementioned embodiments, the elements and characteristics of the disclosure have been combined in a specific form. Each of the elements or characteristics may be considered to be optional unless otherwise described explicitly. Each of the elements or characteristics may be implemented in a form to be not combined with other elements or characteristics. Furthermore, some of the elements or the characteristics may be combined to form an embodiment of the disclosure. The sequence of the operations described in the embodiments of the disclosure may be changed. Some of the elements or characteristics of an embodiment may be included in another embodiment or may be replaced with corresponding elements or characteristics of another embodiment. It is evident that an embodiment may be constructed by combining claims not having an explicit citation relation in the claims or may be included as a new claim by amendments after filing an application.

The embodiment according to the disclosure may be implemented by various means, for example, hardware, firmware, software or a combination of them. In the case of an implementation by hardware, the embodiment of the disclosure may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In the case of an implementation by firmware or software, the embodiment of the disclosure may be implemented in the form of a module, procedure or function for performing the aforementioned functions or operations. Software code may be stored in the memory and driven by the processor. The memory may be located inside or outside the processor and may exchange data with the processor through a variety of known means.

It is evident to those skilled in the art that the disclosure may be materialized in other specific forms without departing from the essential characteristics of the disclosure. Accordingly, the detailed description should not be construed as being limitative from all aspects, but should be construed as being illustrative. The scope of the disclosure should be determined by reasonable analysis of the attached claims, and all changes within the equivalent range of the disclosure are included in the scope of the disclosure.

### INDUSTRIAL APPLICABILITY

The aforementioned preferred embodiments of the disclosure have been disclosed for illustrative purposes, and those skilled in the art may improve, change, substitute, or add various other embodiments without departing from the technical spirit and scope of the disclosure disclosed in the attached claims.

1. A method of processing an image based on an inter prediction mode, the method comprising:
checking merge candidates according to a predetermined sequence and configuring a plurality of candidate groups;
extracting a group index indicating a specific candidate group among the plurality of candidate groups;
extracting a merge index indicating a specific merge candidate within a candidate group indicated by the group index; and
generating a prediction block of a current block using motion information of a merge candidate indicated by the merge index,
wherein the plurality of candidate groups includes a first candidate group including motion information of a spatial neighbor block of the current block and a second candidate group including motion information of a temporal neighbor block of the current block.

2. The method of claim 1,
wherein the plurality of candidate groups further includes a third candidate group including a combined merge candidate which is a combination of motion vectors of candidates of the first candidate group or the second candidate group.

3. The method of claim 1,
wherein a less bit is assigned to a group index indicating the first candidate group than to a group index indicating the second candidate group.

4. The method of claim 1,
wherein the first candidate group includes at least one of a motion vector of a block including a pixel horizontally or vertically neighboring a top left pixel of the current block, a median of motion vectors of blocks neighboring a left side of the current block or a median of motion vectors of blocks neighboring an upper side of the current block.

5. The method of claim 1,
wherein the second candidate group includes a first advanced temporal merge candidate using, as a subblock unit, a motion vector of a reference block specified by a motion vector of a specific merge candidate of the first candidate group.

6. The method of claim 1,
wherein the second candidate group includes a second advanced temporal merge candidate using, as a subblock unit, an average value or median of motion vectors of a spatial neighbor block and temporal neighbor block of the current block.

7. The method of claim 1,
wherein the second candidate group includes a third advanced temporal merge candidate using a motion vector at a top left location or middle location of a reference block, which is specified by a motion vector of a specific merge candidate of the first candidate group.

8. The method of claim 1,
wherein the second candidate group includes a motion vector of a first block including a pixel corresponding to a pixel located to left above from a middle location of the current block or a second block including a pixel corresponding to a top left pixel of the current block, the first and second blocks belonging to a temporal candidate picture.

9. The method of claim 1,
wherein extracting the group index includes determining whether to extract the group index based on a value of the merge index, and
wherein the group index indicating a specific candidate group is extracted among the plurality of candidate groups based on a result of the determination of the extraction.

10. The method of claim 9,
wherein whether to extract the group index is determined based on whether the value of the merge index exceeds a preset value.

11. The method of claim 1,
wherein extracting the group index includes confirming whether a reference picture of the current block corresponds to a slice coded through an intra prediction, and
wherein the group index indicating a specific candidate group is extracted among the plurality of candidate groups if, as a result of the confirmation, the reference picture of the current block does not correspond to a slice coded through an intra prediction.

12. An apparatus for processing an image based on an inter prediction mode, the apparatus comprising:
a candidate group construction unit configured to check merge candidates according to a predetermined sequence and configuring a plurality of candidate groups;
a group index extraction unit configured to extract a group index indicating a specific candidate group among the plurality of candidate groups;
a merge index extraction unit configured to extract a merge index indicating a specific merge candidate within a candidate group indicated by the group index; and
a prediction block generation unit configured to generate a prediction block of a current block using motion information of a merge candidate indicated by the merge index,
wherein the plurality of candidate groups includes a first candidate group including motion information of a spatial neighbor block of the current block and a second candidate group including motion information of a temporal neighbor block of the current block.
